(19) United States
(12) Patent Application Publication
(10) Pub. No.: US 2026/0309411 A1
(43) Pub. Date: Oct. 8, 2026

(54) MULTIPLE HEARTH FURNACE FOR PLACING A SOLID AND A GAS IN CONTACT

(71) Applicants: IFP ENERGIES NOUVELLES, Rueil-Malmaison (FR); TOTALENERGIES ONETECH, COURBEVOIE (FR); THYSSENKRUPP UHDE GMBH, DORTMUND (DE); AVRIL, PARIS (FR); COMMISSARIAT A L'ENERGIE ATOMIQUE ET AUX ENERGIES ALTERNATIVES, Paris (FR); AXENS, Rueil-Malmaison (FR); BIONEXT, VENETTE (FR)

(72) Inventors: Laurent BOURNAY, Rueil-Malmaison Cedex (FR); Sebastien GONNARD, Rueil-Malmaison Cedex (FR); Jean-Philippe HERAUD, Rueil-Malmaison Cedex (FR); Mathieu MORIN, Rueil-Malmaison Cedex (FR); Eric VOLLAND, Rueil-Malmaison Cedex (FR)

(73) Assignees: IFP ENERGIES NOUVELLES, Rueil-Malmaison (FR); TOTALENERGIES ONETECH, COURBEVOIE (FR); THYSSENKRUPP UHDE GMBH, DORTMUND (DE); AVRIL, PARIS (FR); COMMISSARIAT A L'ENERGIE ATOMIQUE ET AUX ENERGIES ALTERNATIVES, Paris (FR); AXENS, Rueil-Malmaison (FR); BIONEXT, VENETTE (FR)

(21) Appl. No.: 19/476,754

(22) PCT Filed: Apr. 4, 2024
(86) PCT No.: PCT/EP2024/059256

§ 371 Date: Oct. 20, 2025

(30) Foreign Application Priority Data
Apr. 21, 2023 (FR) 2304024

(51) Int. Cl. F26B 3/04; F26B 11/18; F26B 21/55; F27B 15/10

(52) U.S. Cl. CPC F26B 3/04; F26B 11/181; F26B 21/55; F27B 15/10; F26B 2200/02; F27M 2003/14

(57) ABSTRACT

A multiple hearth furnace for placing a solid and a gas in contact including: a chamber; a plurality of trays, which are distributed along the longitudinal axis of the chamber; apparatus for circulating the solid in the chamber; and apparatus for circulating the in the chamber, which include a first opening for discharging the gas from the chamber and first gas distribution apparatus, which are associated with at least one of the trays, the first gas distribution apparatus including a plurality of openings, which are arranged in the tray, an air box, which is arranged under the tray, and apparatus for supplying gas to the air box.

### TECHNICAL FIELD

The invention relates to the field of multiple hearth furnaces for bringing a solid into contact with a gas.

In general, multiple hearth furnaces can be implemented in various types of processes, including, in a non-limiting manner, incineration of waste material, calcination for the manufacture of cement, for example, regeneration of activated carbon, or pre-treatment of biomass.

More particularly, in the field of processes for the transformation of biomass, the aim is to produce advanced biofuels (biodiesel and biokerosene) by thermochemical conversion of lignocellulosic biomass. The various steps of this process are in particular (i) pre-treatment, (ii) gasification, (iii) conditioning of the synthesis gas, and (iv) Fischer-Tropsch synthesis.

The first step of pre-treating the biomass is carried out in order to prepare the biomass for its future injection into the gasifier. This step consists in the drying and the gentle thermal degradation of the wood, referred to as torrefaction. This pre-treatment requires a significant supply of heat in order to first of all raise the temperature of the biomass to an adequate level for the drying phase, then remove the water present in the biomass, and finally raise and maintain the temperature of the biomass at an adequate level for the torrefaction operation. This supply of heat is generally effected by bringing the biomass into contact with a stream of hot gas. This pre-treatment step can in particular be carried out by means of a multiple hearth furnace. Multiple hearth furnaces can thus serve as driers and/or torrefaction equipment.

### PRIOR ART

FIG. 1 shows an example of a multiple hearth furnace for bringing a solid material into contact with a gas according to the prior art, described as such in patent application US2016356548A. According to that embodiment, the furnace (10) is made up of a closed cylinder (11), (12) and (13) comprising eight hearths (1) to (8). A central shaft (15) disposed in the cylinder is able to be rotated about the vertical axis (16) by a mechanism (17). The shaft makes it possible to rotate arms (18) which are secured to the shaft and comprise teeth (19), the arms being disposed above the hearths. During the rotation of the shaft, the teeth are moved and, depending on their orientation, move the solid either towards the interior or towards the exterior of the hearth. The solid is introduced at the top of the furnace through a duct (20) and circulates towards the bottom, from hearth to hearth, either through the exterior holes (222), (224), (226) and (228) or through the central holes (211), (213), (215) or (217), before exiting the reactor through an outlet duct (24). The gas, which supplies its heat to the solid, is introduced tangentially either at the bottom of the furnace (counter-current movement relative to the solid via orifices 27), or at the top of the furnace (co-current movement) and circulates through the same peripheral or central holes on each hearth. During its progression, the gas then gives its heat to the solid in order to carry out the thermal treatment. However, the contact between gas and solid is not optimal because the gas is injected tangentially and skims over the surface of the solid. The heat supplied by the gas to the solid is therefore transferred by convection at the surface and then by conduction in the layer of solid. In order to promote the transfer of heat and material, patent application US2016356548 proposes placing vertical baffles above each hearth in order to increase the residence time of the gas and thus the contact time between the gas and the solid. This phenomenon tends to improve the performance of the furnace, but in an insufficient manner.

Also known is document U.S. Pat. No. 4,050,389A, which relates to a process and a device for incinerating waste material in a multiple hearth furnace. More precisely, this document describes means allowing air to be introduced in a conventional manner, that is to say at the base of the furnace, but also at the various hearths, with the aim of adding a sufficient amount of air at each hearth to keep the temperature below a predetermined maximum limit. The means for introducing air at the hearths are in the form of nozzles disposed on a lateral face of the furnace, above each hearth. Such a configuration makes it possible to inject gas at various levels of the furnace, but has the drawback of having limited contact between the solid and the gas. Specifically, in this design, which has the aim of optimal control of the incineration, the gas does not penetrate through the bed of solid, thus limiting the transfer of heat and material.

Also known is document U.S. Pat. No. 2,376,177A which relates to a multiple hearth furnace comprising a rotatable central shaft carrying arms at each hearth, on which solid material is located, said arms being hollow and formed with openings for discharging gas onto the material. Such a configuration makes it possible to inject gas at various levels of the furnace, but has the drawback of injecting the gas above the solid, and therefore of having limited contact between the solid and the gas because the gas does not penetrate into the bed of solid.

Also known is document US2014298716 which relates to a biomass treatment installation in the form of a multiple hearth furnace, comprising a gas injection system at each hearth but with openings at the lateral walls of the furnace. In an optional manner, in order to better control and homogenize the temperature, the injection system may be coupled to a system for optimizing exchanges of heat, for example in the form of a heat pipe connecting the lateral wall of the furnace and each hearth. However, even in that embodiment, the gas is injected at the lateral wall of the enclosure, and this does not permit a homogeneous distribution. That document also describes means for promoting the rotational movement in the furnace, by means of a rod, a metallic plate forming a deflector, or a particular opening. In all cases, those embodiments seek to diffuse heat towards the centre of the furnace chamber, but do not promote homogeneous contact between the solid and the gas on the hearth.

Also known is document GB941635A which relates to a multiple hearth furnace for regeneration of activated carbon, comprising means for introducing additional air into the furnace at a plurality of points. However, the technical solutions disclosed have air tubes disposed at least above hearths of the furnace. Such a configuration has the drawback of injecting the gas above the solid, and therefore of having limited contact between the solid and the gas. If the air tubes were to be disposed below hearths of the furnace, this would not permit homogeneous contact between the solid and the gas on the hearth.

The present invention makes it possible to overcome these drawbacks. In particular, the present invention aims to improve the contact between the gas and the solid during the injection of gas into the furnace, by way of a homogeneous distribution of gas under the layer of solid for at least one of the hearths of the furnace. This contributes to a greater efficiency of the industrial processes which implement multiple hearth furnaces for bringing a solid and a gas into contact.

### SUMMARY OF THE INVENTION

The present invention relates to a multiple hearth furnace for bringing a solid into contact with a gas, said furnace comprising an enclosure of vertical longitudinal axis in a service position, a plurality of hearths disposed in said enclosure and distributed along said longitudinal axis, means for circulating the solid in said enclosure, and means for circulating the gas in said enclosure, said gas circulation means comprising at least one first opening provided in a wall of said enclosure for discharging the gas from said enclosure.

According to the invention, said means for circulating the gas in said enclosure further comprise first means for distributing gas in said furnace which are associated with at least one of said hearths, said first gas distribution means associated with at least one of said hearths comprising a plurality of orifices provided in said at least one hearth, a windbox disposed under said at least one hearth and in fluidic communication with said hearth, and means for supplying gas to said windbox.

According to one implementation of the invention, said first means for distributing gas in said furnace may be associated with each of said hearths of said furnace.

According to one implementation of the invention, the number of orifices in said at least one hearth associated with said first gas distribution means may be between 5 and 60 per m², preferably between 8 and 40 per m², and very preferably between 10 and 30 per m².

According to one implementation of the invention, a bed of particles may be disposed on a surface of said at least one hearth associated with said first gas distribution means.

According to one implementation of the invention, said particles of said bed of particles may be sand particles, beads of crushed glass or untreated glass beads, particles formed on the basis of natural or synthetic zeolite, on the basis of alumina, or on the basis of resins or plastic.

According to one implementation of the invention, when said solid is in the form of particles, said orifices in said at least one hearth associated with said first gas distribution means may be dimensioned so as to comply with a predefined criterion expressed according to a formula of the type:

$$Δ {P}_{P} = α \cdot Δ {P}_{S}$$

in which ΔP_{P} is the pressure drop of the gas on exiting said orifices provided in said hearth, ΔP_{S} is the pressure drop of the gas on exiting said solid in the form of particles disposed on said hearth, and α is a coefficient of proportionality of between 0.01 and 0.7, preferably between 0.05 and 0.5, and more preferably between 0.1 and 0.4.

According to one implementation of the invention, said orifices in said at least one hearth associated with said first gas distribution means may be dimensioned so as to allow a gas velocity of between 0.1 and 20 m/s, preferably between 0.5 and 10 m/s, and very preferably between 0.8 and 5 m/s, through said orifices.

According to one implementation of the invention, said furnace may further comprise second means for distributing gas in said furnace, comprising at least one opening provided in a wall of said enclosure and configured to supply gas directly to said enclosure.

According to one implementation of the invention, said first gas distribution means associated with at least one of said hearths may comprise a second opening provided in a wall of said enclosure, a duct optionally equipped with a valve or with a non-return valve, said duct connecting said second opening to an exterior gas supply circuit.

According to one implementation of the invention, said means for circulating the solid in said enclosure may comprise a shaft, passing through said longitudinal axis of said enclosure, for rotating means in order to move the solid on each of said hearths, said means for moving the solid on each of said hearths being able to comprise a scraping arm.

According to one implementation of the invention, said means for circulating the solid in said enclosure may comprise openings provided in said hearths, said openings provided in said hearths being able to be configured in such a way that said hearths alternatingly have either a central opening or a peripheral opening so as to allow the solid to progress from one hearth to another when said furnace is in operation.

The invention also relates to a process for the drying and/or the torrefaction of a solid of the biomass feedstock type, said process being implemented by means of the multiple hearth furnace according to any one of the embodiments described above.

Other features and advantages of the multiple hearth furnace and of the process according to the invention will become apparent on reading the following description of non-limiting exemplary embodiments, with reference to the appended figures described below.

### LIST OF FIGURES

FIG. 1 shows an example of a multiple hearth furnace for bringing a solid material into contact with a gas according to the prior art.

FIG. 2 illustrates, in a schematic and non-limiting manner, a first embodiment of the multiple hearth furnace according to the invention, in counter-current operation.

FIG. 3 illustrates, in a schematic and non-limiting manner, a first variant of the embodiment in FIG. 2.

FIG. 4 illustrates, in a schematic and non-limiting manner, a second variant of the embodiment in FIG. 2.

FIG. 5 illustrates, in a schematic and non-limiting manner, a development of the variant in FIG. 4.

FIG. 6 illustrates, in a schematic and non-limiting manner, a fourth variant of the embodiment in FIG. 2.

FIG. 7 illustrates, in a schematic and non-limiting manner, a fifth variant of the embodiment in FIG. 2.

FIG. 8 illustrates, in a schematic and non-limiting manner, a second embodiment of the multiple hearth furnace according to the invention, in co-current operation.

FIG. 9A (and FIG. 9B, respectively) shows the change over time of the mean temperature (and of the heating rate, respectively) of biomass particles in the case of the multiple hearth furnace according to the prior art and the multiple hearth furnace according to the invention.

### DESCRIPTION OF THE EMBODIMENTS

The present invention relates to a multiple hearth furnace for bringing a solid into contact with a stream of a gas.

The solid according to the invention may be any type of solid, such as a powder of a mixture of limestone, clay and sand, ore, plastic or else a biomass feedstock.

According to a preferred implementation of the invention in which the system is implemented in the context of a process for the drying and/or torrefaction of a biomass, the solid may correspond to a biomass feedstock. The biomass feedstock can advantageously vary depending on its origin. It may be from wood or from by-products of wood, such as waste material produced by forestry (forest remains), sawmills, wood processing industries. It may also originate from industrial by-products such as sludge or agrifood waste. The biomass may also come from traditional agriculture and be made up of residues such as straw, coppice, bagasse, and also dedicated cultures for energy generation purposes (miscanthus, short rotation coppice, etc.). Finally, it may correspond to organic waste, such as urban waste comprising sewage sludge, household waste may also constitute the feedstock. Preferably, the biomass feedstock can be lignocellulosic biomass or cellulose, and preferably lignocellulosic biomass. The biomass feedstock may also originate from algae. The feedstock may be composed of solid particles. Particularly when the solid according to the invention corresponds to a biomass feedstock, it may contain a certain water content.

The gas according to the invention may be, depending on the intended application, air, but also recycled combustion gases, carbon dioxide, water vapour, or else an inert gas such as helium or nitrogen.

According to a preferred implementation of the invention in which the system is implemented in the context of a process for the drying and/or torrefaction of a biomass, the gas may be an inert gas such as helium, nitrogen, or a mixture of these gases with recycled gases from a previous drying and/or torrefaction step. According to one implementation of the invention in which the system is implemented in the context of a process for the torrefaction of a biomass, the gas may also be water vapour.

According to the invention, the multiple hearth furnace comprises an enclosure whose longitudinal axis, in a service position (that is to say during the use of the device), is oriented vertically. According to the invention, a plurality of hearths are disposed (radially) along this longitudinal axis. The hearths (or at least their median plane) are therefore substantially horizontal in the service position of the multiple hearth furnace.

The multiple hearth furnace according to the invention comprises means for circulating the solid in the enclosure. It is clear that, in the service position, the solid circulates from the top of the enclosure towards the bottom of the enclosure by gravity.

According to one implementation of the invention, the means for circulating the solid may comprise a first opening provided in the enclosure above the upper hearth of the multiple hearth furnace (the term “upper” is taken with reference to the service position), and a second opening provided in the enclosure below the lower hearth of the multiple hearth furnace (the term “lower” is taken with reference to the service position). According to one implementation of the invention, the means for circulating the solid may comprise openings provided in the hearths, so as to allow the solid to pass from one hearth to another.

According to one implementation of the invention, the openings in the hearths are configured in such a way that the hearths alternatingly have either a central opening or a peripheral opening so as to allow the solid to progress from one hearth to another when the furnace is in operation. Advantageously, the means for circulating the solid may comprise a shaft, passing through the longitudinal axis of the enclosure, for rotating the means in order to move the solid on each of the hearths. According to one implementation of the invention, the means for moving the solid on each of the hearths may comprise a scraping arm, for example an arm equipped with teeth.

The multiple hearth furnace according to the invention comprises means for circulating the gas in the enclosure, comprising primary gas distribution means associated with (or dedicated, or specific, or relating to) at least one of the hearths of the multiple hearth furnace. In other words, at least one of the hearths of the multiple hearth furnace comprises (or is associated with) the primary gas distribution means (or primary means for distributing gas).

The primary gas distribution means associated with at least one hearth comprise a plurality of orifices provided in this hearth, at least one windbox disposed under this hearth and in fluidic communication with said hearth (i.e. the windbox and the hearth are configured so as to allow the primary gas to pass between the windbox and the hearth), and means for supplying gas to the windbox. Thus, during its injection, the gas firstly fills the windbox before uniformly penetrating and passing through the thickness of the solid located on the upper part of the hearth comprising a plurality of orifices. This configuration makes it possible to force the gas to pass through the solid, thus promoting the gas-solid contact and allowing a better transfer of heat and material between gas and solid at the hearth or hearths comprising primary gas distribution means. In the text which follows, a hearth of the multiple hearth furnace that comprises a plurality of orifices will be referred to as a perforated hearth.

A windbox is understood to mean a chamber which is intended to be connected to gas supply means and which comprises a plurality of openings intended to distribute the gas. Thus, a windbox makes it possible to homogenize the gas introduced into the chamber and to stabilize the pressure of the gas in the chamber, prior to its distribution. It is clear that the windbox according to the invention, which is associated with a hearth, is supplied with gas by the gas supply means of the primary gas distribution means according to the invention.

Very preferably, the roof (in other words the upper face) of the windbox according to the invention may coincide with the perforated hearth with which it is associated. Thus, the orifices in the perforated hearth allow the gas contained in the windbox to be distributed above the perforated hearth.

According to one implementation of the invention, the base (in other words the lower face) of the windbox associated with a perforated hearth may extend as far as the walls of the enclosure of the multiple hearth furnace. The chamber of the windbox according to this implementation, when it is combined with the very preferred variant in which the roof of the windbox coincides with the perforated hearth with which it is associated, is then formed by the perforated hearth, the base, and the walls of the enclosure of the multiple hearth furnace. The windbox according to this design may be supplied with gas by an opening provided in a wall of the enclosure between the base of the windbox and the perforated hearth. The base of a windbox can have any form, such as a planar or curved plate.

Preferably, a plurality of hearths of the multiple hearth furnace may comprise primary gas distribution means, and very preferably, all of the hearths of the multiple hearth furnace comprise primary gas distribution means. In this way, the transfer of material and heat between gas and solid is optimized over the entire height of the multiple hearth furnace.

According to the invention, the means for circulating the gas further comprise at least one opening, provided in the enclosure, for discharging gas. Advantageously, this opening is either provided above the upper hearth of the multiple hearth furnace in the case of counter-current gas circulation (the term “upper” is taken with reference to the service position), or provided below the lower hearth of the multiple hearth furnace (the term “lower” is taken with reference to the service position) in the case of co-current circulation.

According to one implementation of the invention, the means for supplying gas to the windbox of at least one of the hearths associated with primary gas distribution means may comprise at least one opening provided in the enclosure of the furnace. According to one implementation of the invention, the opening provided in the enclosure for supplying the windbox of at least one of the hearths associated with primary gas distribution means may be connected to a duct which may itself be connected to a gas supply circuit (exterior to the multiple hearth furnace according to the invention), optionally by means of a 2-way valve, a non-return valve or gas flow rate regulation means. A 2-way valve, a non-return valve or gas flow rate regulation means, which are specific to each hearth associated with primary gas distribution means, make it possible to control the injection of gas of one hearth with respect to another. This allows better adaptation to the specifics of the variety of industrial processes implementing multiple hearth furnaces as described above. In particular, the means for regulating the gas flow rate (such as a fan, a butterfly valve or a needle valve) make it possible to inject a separate quantity of gas from one hearth to another, for a greater degree of flexibility.

According to one implementation of the invention, the means for circulating the gas in the furnace may further comprise secondary gas distribution means, in addition to the primary gas distribution means according to the invention. These secondary (or additional) gas injection means may take any form of gas distribution means according to the prior art. According to one implementation of the invention, the secondary gas distribution means may comprise an opening provided in a wall of the enclosure and configured to supply gas directly to the enclosure (in contrast to the primary gas distribution means which initially supply a windbox). According to one implementation of the invention, the secondary gas distribution means may comprise an opening provided in the enclosure below the lower hearth of the multiple hearth furnace in the case of counter-current gas circulation (the term “lower” is taken with reference to the service position), or provided above the upper hearth of the multiple hearth furnace (the term “upper” is taken with reference to the service position) in the case of co-current circulation. These secondary gas distribution means supplement the primary gas distribution means according to the invention, for a greater degree of flexibility of the multiple hearth furnace, in particular better adaptation to the specifics of the variety of industrial processes implementing multiple hearth furnaces as described above.

According to one implementation of the invention, the orifices in at least one of the hearths associated with the primary gas distribution means are distributed on the hearth in a regular manner, that is to say with a constant number of orifices per unit area. Advantageously, the number of orifices in at least one of the perforated hearths may be between 5 and 60 per m², preferably between 8 and 40 per m², and very preferably between 10 and 30 per m². Such distributions of orifices contribute to a homogeneous distribution of the gas over the upper part of the perforated hearth or hearths.

Advantageously, when the solid is in the form of particles, the orifices in at least one of the hearths associated with the primary gas distribution means have smaller dimensions than the dimensions of the particles of the solid, in order to avoid the weeping phenomenon (particles which fall through the injection holes).

According to one implementation of the invention, the orifices in at least one of the hearths associated with the primary gas distribution means are dimensioned so as to allow a gas velocity of between 0.1 and 20 m/s, preferably between 0.5 and 10 m/s, and very preferably between 0.8 and 5 m/s, through each of the orifices.

According to one implementation of the invention, the orifices in at least one of the hearths associated with the primary gas distribution means may be dimensioned so as to comply with a predefined criterion relating to the pressure drop of the gas passing through the distribution orifices of the hearth in question, and to the pressure drop of the gas passing through the solid disposed on the hearth in question. According to one implementation of the invention, when the solid is in the form of particles and when the number of orifices in at least one of the perforated hearths is between 5 and 60 per m², preferably between 8 and 40 per m², and very preferably between 10 and 30 per m², the orifices in at least one of the hearths associated with the primary gas distribution means are dimensioned so as to comply with a predefined criterion expressed according to a formula of the type:

$$Δ {P}_{P} = α \cdot Δ {P}_{S}$$

in which ΔPₚ is the pressure drop of the gas passing through the distribution orifices of the hearth in question, ΔP_{S} is the pressure drop of the gas passing through the solid, notably when said solid is in the form of particles, disposed on the hearth in question, and α is a coefficient of proportionality of between 0.01 and 0.7, preferably between 0.05 and 0.5, and more preferably between 0.1 and 0.4. According to one particular implementation, the coefficient of proportionality α may be equal to 0.3. When the solid is in the form of particles, the solid may then take the form of a bed of particles, and the pressure drop across the solid may then be a function of the height and the porosity of the bed of solid particles. It is perfectly clear to a person skilled in the art that such ranges for the coefficient of proportionality α, combined with a number of orifices per m² defined according to the aforementioned ranges, are sufficient to allow a person skilled in the art to dimension the orifices in a gas distributor hearth on which solid particles would be disposed.

According to one implementation of the invention, the enclosure of the multiple hearth furnace may be of cylindrical or parallelepipedal form. According to this implementation, the openings for the input and the output of the solid into/out of the enclosure may advantageously be respectively disposed in the upper wall and in the lower wall of the enclosure. Advantageously, the section of the enclosure may be constant along the longitudinal axis.

According to one implementation of the invention in which the enclosure is of cylindrical form, the diameter of the enclosure may vary with an inside diameter of between 80 cm and 120 cm, preferably an inside diameter of between 90 and 110 cm, and may vary preferably be 1 m, and the height of the enclosure may vary between 80 cm and 120 cm, preferably between 90 and 110 cm, and may very preferably be 1 m. Such dimensions are conventional for multiple hearth furnaces implemented in industrial processes as described above.

According to one implementation of the invention, the material of the various elements (enclosure, hearths, windbox, etc.) of the multiple hearth furnace may be made of ceramic, a metal which is preferably resistant to corrosion, in particular any type of stainless steel. These materials are specifically resistant to the very high temperatures and to the acid compounds involved in the implementation of processes using this type of furnace, and limit the ability of extractable compounds to migrate into the solid and/or into the gas.

According to a preferred implementation of the invention, the multiple hearth furnace comprises a bed of particles disposed on the surface of at least one of the perforated hearths, preferably on the surface of each of the perforated hearths of the multiple hearth furnace. The bed of particles will increase the pressure drop above the perforated hearth and thus improve the distribution of gas over the entire surface of the perforated hearth or hearths. Advantageously, the bed of particles is topped by a screen, in such a way that the particles are not carried away by the stream of gas coming from the perforated hearths. Moreover, such a screen can also permit a more homogeneous distribution of the gas, thus improving the gas-solid contact. It is clear that the size of the openings in the screen have to be both smaller than the size of the particles of the bed of particles and smaller than the size of the particles of the solid feedstock.

According to one implementation of the invention, the particles of a bed may be any type of particles which are non-reactive (or inert) with respect to the gas and/or which exhibit a significant thermal conductivity (in order to promote the transfer of heat to the solid), such as sand particles, or crushed glass beads or untreated glass beads, particles formed on the basis of natural or synthetic zeolite, on the basis of alumina, or on the basis of resins or plastic. The above-mentioned materials specifically have the advantages of being readily available commercially and of having advantageous thermal and mechanical properties (significant thermal conductivity and good resistance to attrition). According to one implementation of the invention, the height of the bed of particles may be greater than 50% of the spacing between the base of the hearth and the lower part of the means for moving the solid on the hearth in question (for example, in the case of an arm equipped with teeth, the lower part of the means for moving the solid on the hearth in question corresponds to the base of the teeth), preferably greater than 60%, and more preferably greater than 70%. Advantageously, the particle size of the particles of a bed may be greater than the dimensions of the orifices in the hearth in question.

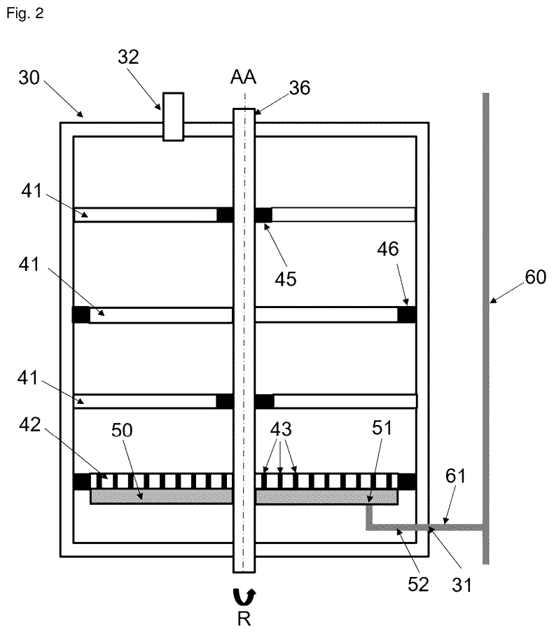

FIG. 2 illustrates, in a schematic and non-limiting manner, a first embodiment of the multiple hearth furnace according to the invention, in counter-current operation. More precisely, this figure shows a multiple hearth furnace comprising an enclosure 30 traversed by a central shaft 36 which is driven in rotation R with respect to the longitudinal axis AA of the enclosure and which is disposed along the vertical axis when the furnace is in operation. The multiple hearth furnace comprises four hearths 41, 42 disposed along the longitudinal axis. According to this embodiment, the hearths 41, 42 are equipped either with a central hole 45 or with a peripheral hole 46, and this is done in an alternating manner from one hearth to another along the longitudinal axis, so as to allow the solid feedstock to pass from one hearth to another (openings in the enclosure for the passage of the solid feedstock are not shown). The means for circulating the gas in the enclosure 30 according to this design comprise primary gas distribution means associated with a single hearth, in this case the lowermost hearth 42 in the enclosure 30. The primary gas distribution means associated with the hearth 42 comprise orifices 43 distributed homogeneously in the hearth 42, a windbox 50 disposed under the hearth 42, the windbox 50 being connected to a gas supply circuit 60, 61 external to the furnace by means of a duct 52 connecting the opening 51 provided in the windbox and the opening 31 provided in the lateral wall of the enclosure. The means for circulating the gas in the enclosure 30 according to this design further comprise an opening 32, provided in the upper wall of the enclosure, for allowing gas to be discharged in counter-current operation. Thus, during its injection, the gas firstly fills the windbox 50 of the perforated hearth 42 before uniformly penetrating and passing through the thickness of the solid (not shown) located on the upper part of the perforated hearth 42. This configuration makes it possible to force the gas to pass through the solid, thus promoting the gas-solid contact and allowing a better transfer of heat and material between gas and solid at the perforated hearth.

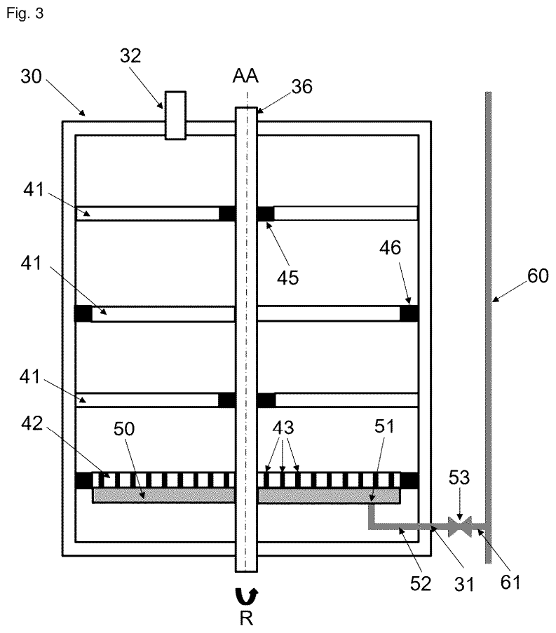

FIG. 3 illustrates, in a schematic and non-limiting manner, a first variant of the embodiment in FIG. 2, which is completely identical to said first embodiment (thus, the common elements will not be described again), with the exception of the presence of a valve 53 along the duct 61 of the gas supply circuit 60, 61 external to the furnace, so as to be able to control the injection of the gas into the enclosure 30.

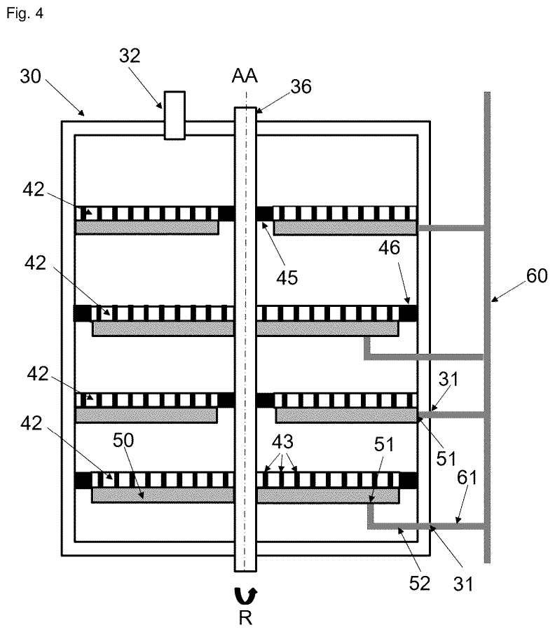

FIG. 4 illustrates, in a schematic and non-limiting manner, a second variant of the embodiment in FIG. 2, which is completely identical to said first embodiment (thus, the common elements will not be described again), with the exception of the fact that all the hearths 42 of the enclosure are hearths comprising primary gas distribution means, in this case identical to the primary gas distribution means of the hearth 42 in FIG. 2. This configuration makes it possible to promote the gas-solid contact for each of the hearths of the multiple hearth furnace, and thus to obtain a better performance of the multiple hearth furnace with regard to the transfer of heat between the gas and the solid.

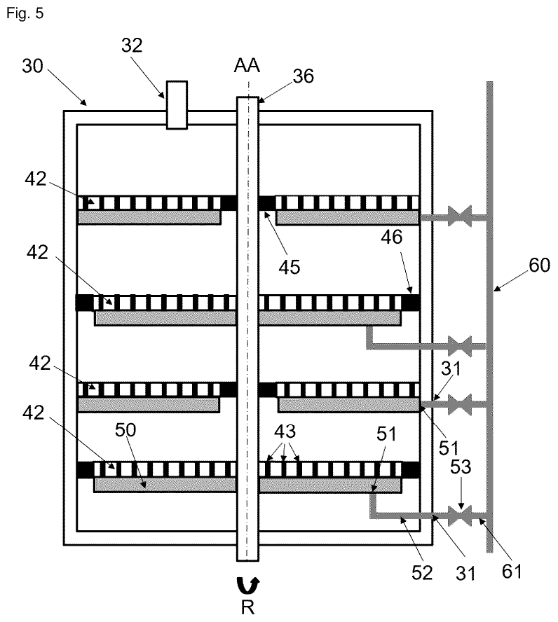

FIG. 5 illustrates, in a schematic and non-limiting manner, a development of the variant in FIG. 4, which is completely identical to said variant (thus, the common elements will not be described again), with the exception of the presence of a valve 53 along each duct 61 of the gas supply circuit 60, 61 external to the furnace. This configuration makes it possible to control the injection of the gas into the enclosure 30 in an independent manner from one hearth to another, as a function, for example, of results of measurements for monitoring the process being implemented, such as measurements of gas flow rate, temperature, pressure, gas composition, etc.

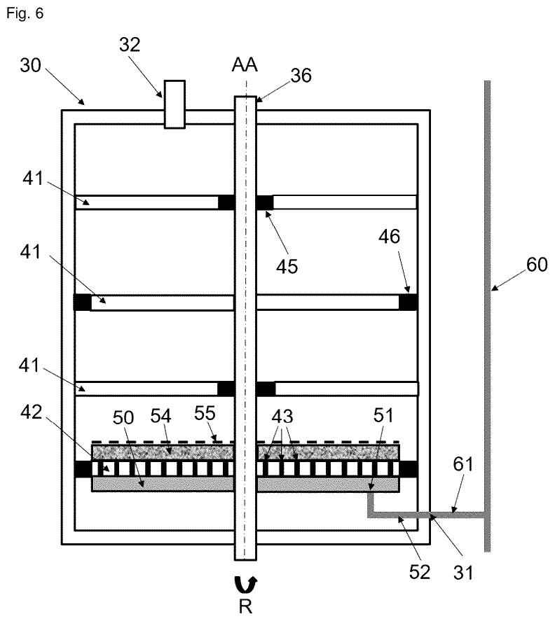

FIG. 6 illustrates, in a schematic and non-limiting manner, a fourth variant of the embodiment in FIG. 2, which is completely identical to said first embodiment (thus, the common elements will not be described again), with the exception of the fact that a bed of particles 54 is disposed on the surface of the perforated hearth 42 and is topped by a screen 55 on which the solid to be thermally treated is distributed. The bed of particles makes it possible to increase the pressure drop above the perforated hearth and thus to improve the distribution of gas over the entire surface of the hearth. The screen makes it possible to prevent the particles of the bed of particles from being carried away by the stream of gas and from mixing with the solid particles circulating on the hearths. Moreover, the screen contributes to a more homogeneous distribution of the gas.

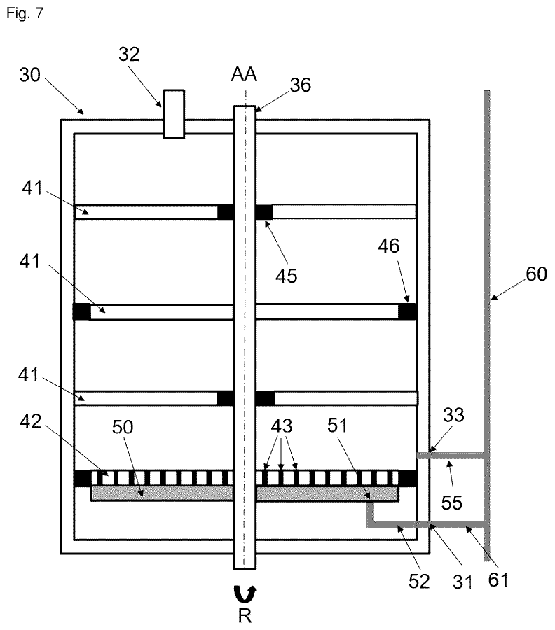

FIG. 7 illustrates, in a schematic and non-limiting manner, a fourth variant of the embodiment in FIG. 2, which is completely identical to said first embodiment (thus, the common elements will not be described again), with the exception of the fact that the means for circulating the gas comprise secondary gas distribution means, in the form of an opening 33 provided above the lower hearth (in this case the perforated hearth 42) of the furnace, allowing an additional supply of gas via the duct 55 connected to the gas supply circuit 60, 61 external to the furnace. These secondary gas distribution means make it possible to supplement the primary gas distribution means associated with the hearth 42, for better adaptation to the specifics of the variety of industrial processes. It is also possible to connect the duct 55 to a dedicated secondary gas circulation line which is different from the line of the primary gas supply circuit 60.

It is clear that the variants in FIGS. 3 to 7 can be combined with one another.

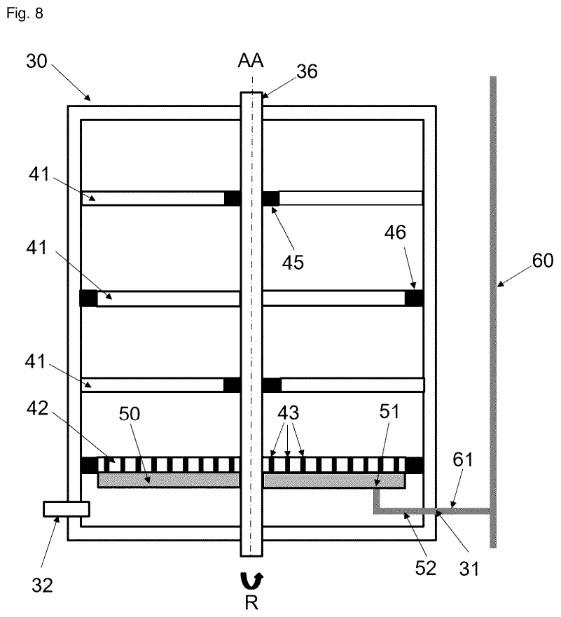

FIG. 8 illustrates, in a schematic and non-limiting manner, a second embodiment of the multiple hearth furnace according to the invention, in co-current operation. This second embodiment is completely identical to the first embodiment (thus, the common elements will not be described again), with the exception that in this design the means for circulating the gas in the enclosure 30 comprises an opening 32 provided in a part of a lateral wall of the enclosure 30 situated under the lower hearth (in this case the perforated hearth 42) of the furnace, so as to allow gas to be discharged in co-current operation of the furnace. It is clear that the variants in FIGS. 3 to 7 can be combined with the embodiment of FIG. 8.

The invention also relates to a process for the drying and/or torrefaction of a biomass feedstock, implemented by means of the multiple hearth furnace as described above according to any one of its variants.

### EXAMPLES

Features and advantages of the system according to the invention will become more clearly apparent on reading about the following example of application.

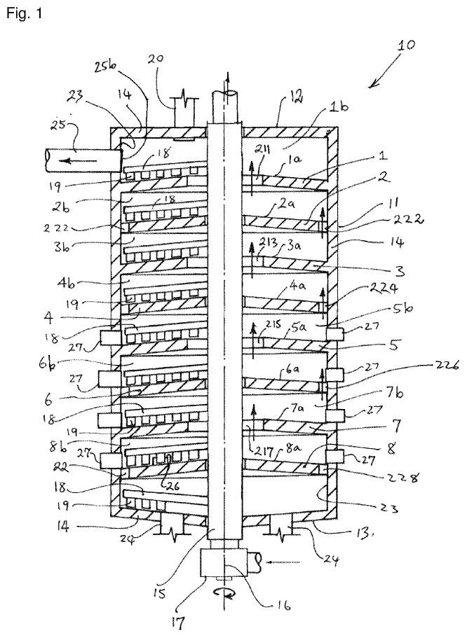

This example of application seeks to compare the heating rate of a biomass-type material disposed on a hearth of a multiple hearth furnace according to the prior art (that is to say with tangential injection of gas) described in relation to FIG. 1, and the heating rate of a biomass-type material disposed on a hearth associated with primary gas distribution means of a multiple hearth furnace according to the invention.

The heating rates are estimated using numerical simulations carried out with the CPFD Barracuda™ software. The geometric data of the simulation and the operating/limit conditions are indicated below:
Features of the enclosure: cylinder with a diameter of 1 m and a height of 1 m, comprising an opening for the output of gas in the form of a cylindrical tube with a diameter of 0.17 m and a height of 0.1 m which is provided in the upper wall of the cylindrical enclosure, this opening being placed under atmospheric conditions;
The furnace is kept at a constant temperature equal to 150° C.;
The enclosure of the multiple hearth furnace according to the prior art comprises three injection cylinders for the tangential injection of gas which have a diameter of 0.1 m and are located 0.3 m above the hearth in question.
The perforated hearth of the multiple hearth furnace according to the invention comprises 21 orifices distributed uniformly on the hearth, corresponding to a number of orifices per m² of the hearth of about 27.
The gas used is nitrogen at 280° C. The total gas flow rate at the input is 0.13 kg/s, representing a superficial velocity of the gas through the furnace of 0.3 m/s.
A layer of biomass with a height of 0.2 m is disposed above the hearth of the multiple hearth furnace according to the prior art and above the perforated hearth of the multiple hearth furnace according to the invention. The biomass particles have a mean diameter of 2 cm and an initial temperature of 20° C.

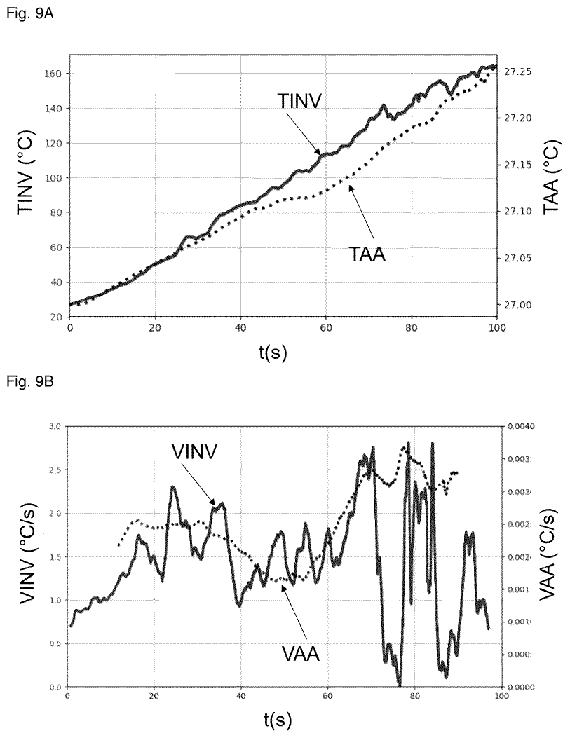

A numerical simulation with a duration of 100 s is carried out for the multiple hearth furnace according to the prior art and for the multiple hearth furnace according to the invention. The mean temperature of the biomass particles is recorded over time, on the basis of which it is possible to deduce the heating rate of the biomass particles. FIG. 9A (and FIG. 9B, respectively) shows the change over time t of the mean temperature (and of the heating rate, respectively) of biomass particles in the case of the multiple hearth furnace according to the prior art (curve and scale TAA; and, respectively, curve and scale VAA) and the multiple hearth furnace according to the invention (curve and scale TINV; and, respectively, curve and scale VINV). It is possible to observe a much more rapid rise in temperature in the case of the multiple hearth furnace according to the invention, thus making it possible to increase the heating rate by a factor of 600 with respect to the multiple hearth furnace according to the prior art. Such an increase in the heating rate makes it possible to reduce not only the production time but also the energy consumption of the furnace.

Thus, the multiple hearth furnace according to the invention permits a more homogeneous distribution of the gas over the surface of a hearth comprising primary gas distribution means, and this permits improved contact between the gas and the solid disposed on this hearth, and thus greater efficiency of the industrial processes implementing such a furnace.

1. Multiple hearth furnace for bringing a solid and a gas into contact, said furnace comprising an enclosure (30) of vertical longitudinal axis (AA) in a service position, a plurality of hearths (41, 42) disposed in said enclosure and distributed along said longitudinal axis (AA), means (45, 46) for circulating the solid in said enclosure, and means (31, 32, 33, 45, 46, 43, 50, 51, 52) for circulating the gas in said enclosure (30), said gas circulation means comprising at least one first opening (32) provided in a wall of said enclosure for discharging the gas from said enclosure (30), characterized in that said means (31, 32, 33, 45, 46, 43, 50, 51, 52) for circulating the gas in said enclosure (30) further comprise first means (31, 43, 50, 51, 52) for distributing gas in said furnace which are associated with at least one of said hearths (42), said first gas distribution means (31, 43, 50, 51, 52) associated with at least one of said hearths (42) comprising a plurality of orifices (43) provided in said at least one hearth (42), a windbox (50) disposed under said at least one hearth (42) and in fluidic communication with said hearth, and means (31, 51, 52) for supplying gas to said windbox.

2. Multiple hearth furnace according to claim 1, wherein said first means (31, 43, 50, 51, 52) for distributing gas in said furnace are associated with each of said hearths (41, 42) of said furnace.

3. Multiple hearth furnace according to claim 1, wherein the number of orifices (43) in said at least one hearth (42) associated with said first gas distribution means is between 5 and 60 per m², preferably between 8 and 40 per m², and very preferably between 10 and 30 per m².

4. Multiple hearth furnace according to claim 1, wherein a bed of particles (54) is disposed on a surface of said at least one hearth associated with said first gas distribution means.

5. Multiple hearth furnace according to claim 4, wherein said particles of said bed of particles (54) are sand particles, beads of crushed glass or untreated glass beads, particles formed on the basis of natural or synthetic zeolite, on the basis of alumina, or on the basis of resins or plastic.

6. Multiple hearth furnace according to claim 3, wherein, when said solid is in the form of particles, said orifices (43) in said at least one hearth (42) associated with said first gas distribution means (31, 43, 50, 51, 52) are dimensioned so as to comply with a predefined criterion expressed according to a formula of the type:
$$Δ {P}_{P} = α \cdot Δ {P}_{S}$$
in which ΔPₚ is the pressure drop of the gas on exiting said orifices (43) provided in said hearth (42), APs is the pressure drop of the gas on exiting said solid in the form of particles disposed on said hearth (42), and a is a coefficient of proportionality of between 0.01 and 0.7, preferably between 0.05 and 0.5, and more preferably between 0.1 and 0.4.

7. Multiple hearth furnace according to claim 1, wherein said furnace further comprises second means (33) for distributing gas in said furnace, comprising at least one opening (33) provided in a wall of said enclosure and configured to supply gas directly to said enclosure.

8. Multiple hearth furnace according to claim 1, wherein said first gas distribution means (31, 43, 50, 51, 52) associated with at least one of said hearths (42) comprise a second opening (31) provided in a wall of said enclosure, a duct (61) optionally equipped with a valve (53) or with a non-return valve, said duct (61) connecting said second opening (31) to an exterior gas supply circuit (60).

9. Multiple hearth furnace according to claim 1, wherein said means for circulating the solid (45, 46) in said enclosure (30) comprise a shaft (36), passing through said longitudinal axis (AA) of said enclosure (30), for rotating means in order to move the solid (45, 46) on each of said hearths (41, 42), said means for moving the solid (45, 46) on each of said hearths (41, 42) comprising a scraping arm.

10. Multiple hearth furnace according to claim 1, wherein said means for circulating the solid (45, 46) in said enclosure (30) comprise openings (45, 46) provided in said hearths (41, 42), said openings (45, 46) provided in said hearths (41, 42) being configured in such a way that said hearths (41, 42) alternatingly have either a central opening (45) or a peripheral opening (46) so as to allow the solid to progress from one hearth (41, 42) to another when said furnace is in operation.

11. Process for the drying and/or the torrefaction of a solid of the biomass feedstock type, said process being implemented by means of the multiple hearth furnace according to claim 1.
